(19) United States
(12) Patent Application Publication
(10) Pub. No.: US 2025/0028270 A1
(43) Pub. Date: Jan. 23, 2025

(54) IMAGE FORMING APPARATUS

(71) Applicant: CANON KABUSHIKI KAISHA, Tokyo (JP)

(72) Inventors: RYU ITO, Shizuoka (JP); HIROSHI HAGIWARA, Shizuoka (JP)

(21) Appl. No.: 18/775,902

(22) Filed: Jul. 17, 2024

(30) Foreign Application Priority Data
Jul. 20, 2023 (JP) 2023-118137

(51) Int. Cl. G03G 15/00; G03G 15/01; G03G 15/16

(52) U.S. Cl. CPC G03G 15/5058; G03G 15/0131; G03G 15/161; G03G 15/55; G03G 2215/00059; G03G 2215/00063

(57) ABSTRACT

In an image forming apparatus, a length of a patch pattern from a first patch to a last patch included in the patch pattern is longer than a circumferential length that is a length of an intermediate transfer belt in a conveyance direction, an engine control unit forms patches included in a range within the circumferential length in a first density (low density), forms patches included in ranges beyond the circumferential length in a second density (high density) darker than the first density, from among the patches included in the patch pattern, and executes image adjustment control.

### BACKGROUND

### Field

The present disclosure relates to an image forming apparatus using an electric photographic method, and also relates to image adjustment control.

### Description of the Related Art

Image forming apparatuses generally have an image adjustment function of automatically executing color misregistration correction and image density adjustment to achieve precise color reproducibility and color stability. In the image adjustment function, a plurality of measurement images (patches) is formed on a belt serving as a rotation body, and the patches are detected by a sensor mounted on the image forming apparatus. The image adjustment function involves calculation of a color misregistration amount and a density based on a detection timing of the patches and an amount of adhered toner, and determination of an optimum image creation condition based on a result of the calculation. An image forming apparatus discussed in Japanese Patent Application Laid-Open No. 2014-106418 executes patch formation control and detection control, and executes image density adjustment together with color misregistration correction, whereby the execution time of the image adjustment function is shortened.

Patches formed on a belt in the image adjustment function are detected by a sensor and removed from the belt by a cleaning unit. In this process, the patches are sometimes not completely removed by the cleaning unit, and the toner remains on the belt. If patches for the image adjustment function are formed on a place where the above-described cleaning failure has occurred, a detection accuracy may be degraded because of the influence of residual toner. Thus, patches for the image adjustment function are generally formed within a range of one rotation of the belt.

Meanwhile, there is a demand for an increase in the number of patches to improve a detection accuracy, and a belt length is shortened along with downsizing of the apparatuses. This arises an issue that a patch pattern cannot be fit in a range of one rotation of the belt. In this case, the patch pattern is divided into a plurality of portions which can be fit in the range of one rotation of the belt, and the image adjustment function and the cleaning operation are executed alternately, which however prolongs an execution time taken for the image adjustment function.

### SUMMARY

In consideration of the above-described situation, the present disclosure is directed to a technique for reducing the execution time of the image adjustment function and at the same time maintaining a detection accuracy of the image adjustment function.

According to some embodiments, an image forming apparatus includes a forming unit configured to form an adjustment toner image which includes a plurality of toner images for adjustment of image density, an intermediate transfer body on a surface of which the adjustment toner image is formed by the forming unit, a detection unit configured to detect the surface of the intermediate transfer body or the adjustment toner image; and a control unit configured to execute image adjustment control including adjustment of the image density, based on a detection result acquired by the detection unit detecting the adjustment toner image, wherein a length of the adjustment toner image from a first toner image to a last toner image included in the adjustment toner image is longer than a circumferential length that is a length of the intermediate transfer body in a conveyance direction, and wherein, among the plurality of toner images included in the adjustment toner image, the control unit forms toner images included in a range within the circumferential length in a first density, forms toner images included in a range beyond the circumferential length in a second density darker than the first density, and executes the image adjustment control.

According to some embodiments, an image forming apparatus includes a forming unit configured to form adjustment toner image which includes a plurality of toner images for image adjustment, an intermediate transfer body on a surface of which the adjustment toner image is formed by the forming unit, a first detection unit configured to detect the surface of the intermediate transfer body or the adjustment toner image, a removing unit configured to remove the adjustment toner image formed on the intermediate transfer body, and a control unit configured to execute image adjustment control based on a detection result acquired by the first detection unit detecting the adjustment toner image, wherein the image forming apparatus further includes a second detection unit configured to detect whether toner remains on the intermediate transfer body after removal of the adjustment toner image by the removing unit, wherein a length of the adjustment toner image from a first toner image to a last toner image included in the adjustment toner image is longer than a circumferential length that is a length of the intermediate transfer body in a conveyance direction, and wherein, after removal of toner images included in a range within the circumferential length from among the toner images included in the adjustment toner image by the removing unit, the control unit causes the second detection unit to detect whether toner remains.

According to yet other embodiments, an image forming apparatus includes a forming unit configured to form an adjustment toner image which includes a plurality of toner images for image adjustment, an intermediate transfer body on a surface of which the adjustment toner image is formed by the forming unit, a detection unit configured to detect the surface of the intermediate transfer body or the adjustment toner image, a removing unit configured to remove the adjustment toner image formed on the intermediate transfer body, and a control unit configured to execute image adjustment control based on a detection result acquired by the detection unit detecting the adjustment toner image, wherein the image forming apparatus further includes a prediction unit configured to predict whether cleaning failure is to occur after removal of the adjustment toner image formed on the intermediate transfer body by the removing unit, wherein a length of the adjustment toner image from a first toner image to a last toner image included in the adjustment toner image is longer than a circumferential length that is a length of the intermediate transfer body in a conveyance direction, wherein, in a case where the prediction unit predicts occurrence of the cleaning failure, the control unit executes first control to cause the forming unit to form toner images included in a range beyond the circumferential length, from among the plurality of toner images included in the adjustment toner image, after removal of toner images, which have been included within the circumferential length and formed on the intermediate transfer body from among the toner images included in the adjustment toner image, by the removing unit, and then removal of toner remaining on the intermediate transfer body by the removing unit, and wherein, in a case where the prediction unit predicts non-occurrence of the cleaning failure, the control unit executes second control to form the toner images included in the range beyond the circumferential length, from among the plurality of toner images included in the adjustment toner image, after removal of toner images, which have been included within the circumferential length and formed on the intermediate transfer body from among the toner images included in the adjustment toner image.

According to the present disclosure, it is possible to reduce the execution time of the image adjustment function and at the same time maintain a detection accuracy of an image adjustment operation.

Further features of the present disclosure will become apparent from the following description of exemplary embodiments with reference to the attached drawings.

### BRIEF DESCRIPTION OF THE DRAWINGS

FIG. 1A is a schematic diagram of an image forming apparatus, and FIG. 1B is a schematic configuration diagram of a reflected light sensor according to a first exemplary embodiment.

FIG. 2 is a block diagram of the image forming apparatus according to the first exemplary embodiment.

FIG. 3A is a flowchart illustrating color misregistration correction control, and FIG. 3B is a schematic diagram illustrating a patch pattern according to the first exemplary embodiment.

FIG. 4A is a flowchart illustrating image density adjustment control, and FIG. 4B is a schematic diagram illustrating a patch pattern according to the first exemplary embodiment.

FIGS. 5A to 5C are diagrams illustrating patch formation control according to the first exemplary embodiment.

FIG. 6 is a block diagram of an image forming apparatus according to a second exemplary embodiment.

FIG. 7A is a flowchart illustrating cleaning failure detection control, and FIG. 7B is a schematic diagram of a patch pattern according to the second exemplary embodiment.

FIG. 8 is a flowchart illustrating retry control according to the second exemplary embodiment.

FIG. 9 is a block diagram of an image forming apparatus according to a third exemplary embodiment.

FIG. 10A is a flowchart illustrating cleaning failure prediction control, and FIG. 10B is a diagram illustrating a result of the prediction control according to the third exemplary embodiment.

### DESCRIPTION OF THE EMBODIMENTS

Hereinafter, various exemplary embodiments, features, and aspects of the present disclosure will be described in detail with reference to the drawings. The constituent elements described in these exemplary embodiments are merely examples, and unless otherwise specified, the scope of the present disclosure is not intended to be limited only to them.

### (General Description of Image Forming Apparatus)

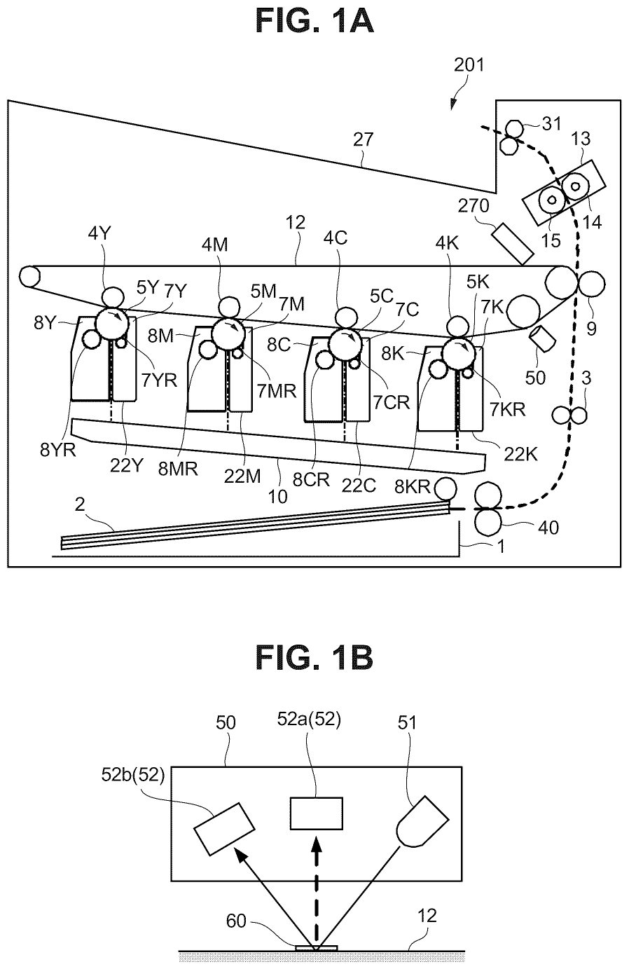

Hereinafter, an image forming apparatus 201 according to a first exemplary embodiment to which the present disclosure can be applied is described with reference to FIGS. 1A and 1B. A configuration of an entire laser printer engine as a color image forming apparatus is schematically described with reference to FIG. 1A. The laser printer engine forms electrostatic latent images by using image light formed based on pixel signals transmitted from a controller unit (not illustrated), develops the electrostatic latent images into visible images, and superimposes and transfers the visible images to form a color visible image. The laser printer engine transfers the color visible image to a sheet 2, and fixes the color visible image on the sheet 2. An image forming unit includes stations of respective development colors arranged next to each other and an intermediate transfer belt 12 serving as an intermediate transfer body. The stations each include a photosensitive drum 5, a charging device 7 serving as a charging unit, a development device 8 serving as a development unit, and a primary transfer roller 4 serving as a primary transfer unit. More specifically, for example, the photosensitive drums 5 are photosensitive drums 5Y, 5M, 5C, and 5K. The characters Y, M, C, and K represent Yellow, Magenta, Cyan, and Black, respectively. The characters Y, M, C, and K, representing respective colors are omitted unless a member related to a specific color is to be described.

The photosensitive drum 5, the charging device 7, and the development device 8 are mounted on a cartridge 22 attachable to and detachable from a main body of the image forming apparatus 201. The photosensitive drum 5 includes an aluminum cylinder and an organic photo conductive layer applied on an outer circumferential surface of the aluminum cylinder. The photosensitive drum 5 is rotated by a driving force transmitted from a driving motor (not illustrated), and the driving motor rotates the photosensitive drum 5 in a clockwise direction in accordance with an image forming operation. A scanner unit 10 emits exposure light to the photosensitive drums 5 and selectively exposes the surfaces of the photosensitive drums 5 to the exposure light, whereby electrostatic latent images are formed on the surfaces of the photosensitive drums 5. Four charging devices 7Y, 7M, 7C, and 7K for charging the photosensitive drums 5Y, 5M, 5C, and 5K, respectively, include charging rollers 7YR, 7MR, 7CR, and 7KR, respectively.

In order to visualize the electrostatic latent images, the image forming apparatus 201 includes four development devices 8Y, 8M, 8C, and 8K in the respective stations to develop images of yellow (Y), magenta (M), cyan (C), and black (K). The development devices 8Y, 8M, 8C, and 8K include development rollers 8YR, 8MR, 8CR, and 8KR.

In formation of a color image, the intermediate transfer belt 12 is rotated in a counterclockwise direction while being in contact with the photosensitive drums 5, and a primary transfer voltage is applied to the primary transfer rollers 4 to cause visible images to be sequentially superimposed and transferred onto the intermediate transfer belt 12, which is primary transfer and a color visible image is formed. In secondary transfer, the intermediate transfer belt 12 transfers the color visible image to the sheet 2 by nipping and conveying the sheet 2 at a position of secondary transfer rollers 9. Members which contribute to formation of the color visible image on the intermediate transfer belt 12 serving as an intermediate transfer body are included in a forming unit. The primary transfer rollers 4 and the secondary transfer rollers 9 are rotated by the rotation of the intermediate transfer belt 12. The sheets 2 are stored in a sheet feeding tray 1, and conveyed to the secondary transfer rollers 9 through a feeding roller 40 and a registration roller pair 3.

A fixing unit 13 conveys the sheet 2 and fixes an unfixed color visible image transferred to the sheet 2 during the conveyance. The fixing unit 13 includes a fixing roller 14 for application of heat to the sheet 2 and a pressure roller 15 causing the sheet 2 to be pressed against the fixing roller 14. Both the fixing roller 14 and the pressure roller 15 have a hollow shape, and the fixing roller 14 includes a heater built into the inner portion. The heater is controlled so that the fixing roller 14 is kept at an appropriate temperature. The sheet 2 bearing the color visible image is conveyed, heated, and pressurized by the fixing roller 14 and the pressure roller 15, which fixes toner on a surface of the sheet 2. After the visible image is fixed on the sheet 2, the sheet 2 is discharged to a discharge portion 27 by a discharge roller 31, and the image forming operation is ended.

A reflected light sensor 50 that serves as a detection unit (first detection unit) and faces the intermediate transfer belt 12 is disposed in the image forming apparatus 201 in FIG. 1A, and the reflected light sensor 50 can detect a surface of the intermediate transfer belt 12 or a patch pattern 60 (see FIG. 1B) formed on the surface of the intermediate transfer belt 12. The patch pattern 60 formed and used for detection by the reflected light sensor 50 is collected by a cleaning unit 270, so that a state where the intermediate transfer belt 12 has no stain on its surface can be maintained.

Each toner image that is used for image adjustment control is also called a patch, and a patch pattern includes a plurality of patches.

### (Reflected Light Sensor)

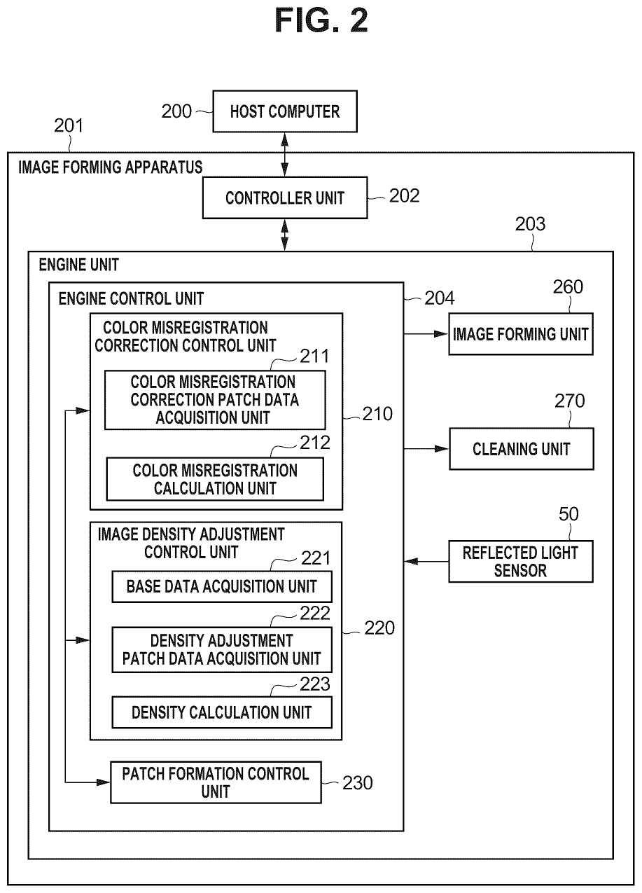

FIG. 1B is a diagram illustrating a configuration of the reflected light sensor 50. The reflected light sensor 50 includes a light emitting element 51, such as a light emitting diode (LED), a light receiving element 52, such as photodiodes, an integrated circuit (IC) (not illustrated) which processes received-light data, and a holder (not illustrated) housing these elements. The light emitting element 51 irradiates the intermediate transfer belt 12 with light. The light receiving element 52 receives light reflected from a surface of the intermediate transfer belt 12 or the patch pattern 60 formed on the intermediate transfer belt 12 and detects the amount of reflected light. The light receiving element 52 includes light receiving elements 52a and 52b. The light receiving element 52a detects diffused reflected light and outputs voltage equivalent to the amount of diffused reflected light. The light receiving element 52b detects specular reflected light and outputs voltage equivalent to the amount of specular reflected light. Since both the specular reflected light and the diffused reflected light are detected, densities of the patch pattern 60 in high densities to low densities is able to be detected. The reflected light sensor 50 outputs the detected specular reflected light and the diffused reflected light as voltages to an engine control unit 204 described below (see FIG. 2). Hereinafter, a result acquired by detecting the diffused reflected light and a result acquired by detecting the specular reflected light may be referred to as a diffused reflected light amount and a specular reflected light amount, respectively. The engine control unit 204 functions as a control unit that executes image adjustment control including adjustment of image densities based on a detection result acquired by the reflected light sensor 50 through detection of the below-described adjustment toner images (toner images or patches to be used for measurement).

### (Function Block Diagram)

FIG. 2 is a function block diagram according to the present exemplary embodiment. The image forming apparatus 201 includes a controller unit 202 and an engine unit 203. A host computer 200 or the controller unit 202 may include one or more processors and executes control to form toner images (patches) of respective colors on the intermediate transfer belt 12 and executes image adjustment control. The engine unit 203 includes the engine control unit 204, an image forming unit 260, the reflected light sensor 50, and the cleaning unit 270. The engine control unit 204 controls various operations of an engine. The image forming unit 260 executes control of laser and high voltage and forms the patch pattern 60 on the intermediate transfer belt 12. The cleaning unit 270 executes cleaning of the intermediate transfer belt 12.

The engine control unit 204 includes a color misregistration correction control unit 210, an image density adjustment control unit 220, and a patch formation control unit 230. As described below, the patch formation control unit 230 executes control to form a patch pattern for image adjustment control. The color misregistration correction control unit 210 uses the reflected light sensor 50 to detect color misregistration correction patches for image adjustment control that is performed to correct color misregistration of a plurality of colors, and acquires a result of the detection via a color misregistration correction patch data acquisition unit 211. The color misregistration correction patches are formed by the patch formation control unit 230. A color misregistration calculation unit 212 calculates a color misregistration amount with respect to a reference color, based on the result acquired by the color misregistration correction patch data acquisition unit 211. The color misregistration correction control unit 210 feeds back a result of the calculation to the image forming unit 260, and the result is reflected on an image forming timing of each color. By the above-described control, the engine control unit 204 adjusts color misregistration with respect to the reference color.

A detection result of image density adjustment patches formed by the patch formation control unit 230 and detected by the reflected light sensor 50 is acquired by the image density adjustment control unit 220 via a density adjustment patch data acquisition unit 222. A detection result of a surface of the intermediate transfer belt 12 by the reflected light sensor 50 is also acquired by the image density adjustment control unit 220 via a base data acquisition unit 221. A density calculation unit 223 uses the results acquired by the base data acquisition unit 221 and the density adjustment patch data acquisition unit 222 to calculate densities of the patches. The image density adjustment control unit 220 feeds back a result of the calculation to the image forming unit 260, and the result is reflected on a process forming condition. By the above-described control, the engine control unit 204 adjusts a maximum density and a halftone gradation characteristic of each color.

### (Color Misregistration Correction Control Unit)

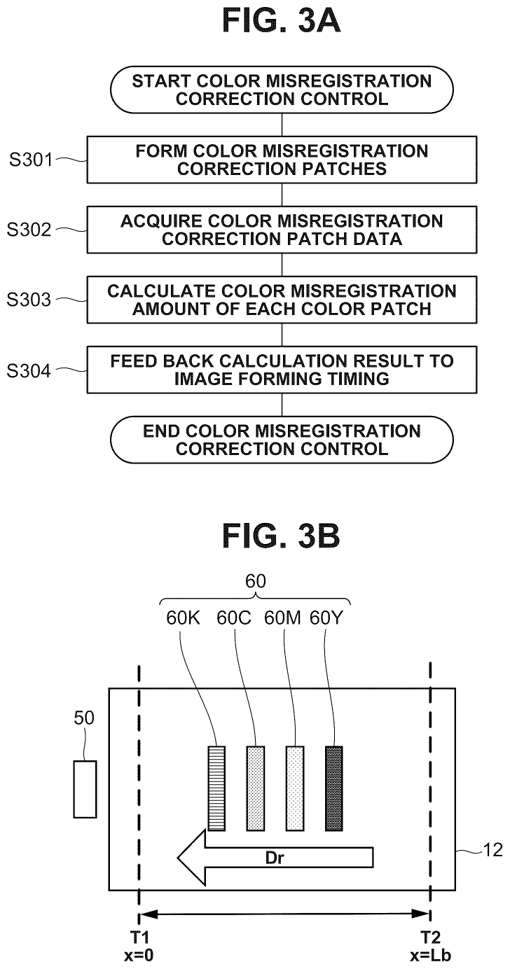

A processing procedure of color misregistration correction control that is executed by the color misregistration correction control unit 210 of the present exemplary embodiment is described with reference to a flowchart in FIG. 3A. In step S301, the color misregistration correction control unit 210 uses the patch formation control unit 230 to form patches 60K, 60C, 60M, and 60Y for color misregistration correction, illustrated in FIG. 3B, on the intermediate transfer belt 12.

### (Color Misregistration Correction Patches)

FIG. 3B illustrates a patch pattern 60 that is formed on the intermediate transfer belt 12 by the patch formation control unit 230 and is used for the color misregistration correction. Specifically, the patch pattern 60 for the color misregistration correction includes the patch 60Y in yellow, the patch 60M in magenta, the patch 60C in cyan and the patch 60K in black. The patches 60Y to 60K are formed in the order of Y, M, C, and K, from the upstream to the downstream in a conveyance direction Dr of the intermediate transfer belt 12. Thus, the reflected light sensor 50 detects the patch pattern 60 in the order of the patches 60K, 60C, 60M, and 60Y.

The patch pattern 60 is formed in a direction orthogonal to the conveyance direction Dr at a position detectable by the reflected light sensor 50. A reference position T1 indicates a position on the intermediate transfer belt 12 serving as a rotation body, and a reference position T2 indicates a position at one rotation away from the reference position T1, i.e., at a length Lb equivalent to the length of the intermediate transfer belt 12 (hereinafter, also called a circumferential length Lb) away from the reference position T1. The reference position T1 is also expressed as x=0, and the reference position T2 is also expressed as x=Lb. Since the intermediate transfer belt 12 is an endless rotation body, the reference position T1 practically coincides with the reference position T2 (T1=T2).

Referring back to FIG. 3A, in step S302, the color misregistration correction control unit 210 acquires patch data via the color misregistration correction patch data acquisition unit 211. The patch data is data acquired by reading an output (e.g., voltage) from the reflected light sensor 50. In FIG. 3B, the black patch 60K which firstly reaches the reflected light sensor 50 is used as a patch of a reference color (hereinafter, called a reference color patch), and timing data about reaching timings of the other color patches 60C, 60M, and 60Y is acquired. In the acquisition of the timing data, a timer (not illustrated) included in the engine control unit 204 is used to measure detection timings of the patches 60C, 60M, and 60Y by taking a detection timing of the patch 60K as a reference.

In step S303, the color misregistration correction control unit 210 uses the color misregistration calculation unit 212 to calculate a color misregistration amount of each color with respect to the color K serving as a reference color, based on the timing data on the color misregistration correction patches acquired by the color misregistration correction patch data acquisition unit 211 in step S302. The color misregistration calculation unit 212 uses pre-stored information about a relationship between timing data and a color misregistration amount in a form of, for example, a table and a relational expression in a storage unit (not illustrated) to calculate the color misregistration amount. In step S304, the color misregistration correction control unit 210 feeds back a result of the calculation to the image forming timing of an operation of the image forming unit 260.

### (Image Density Adjustment Control Unit)

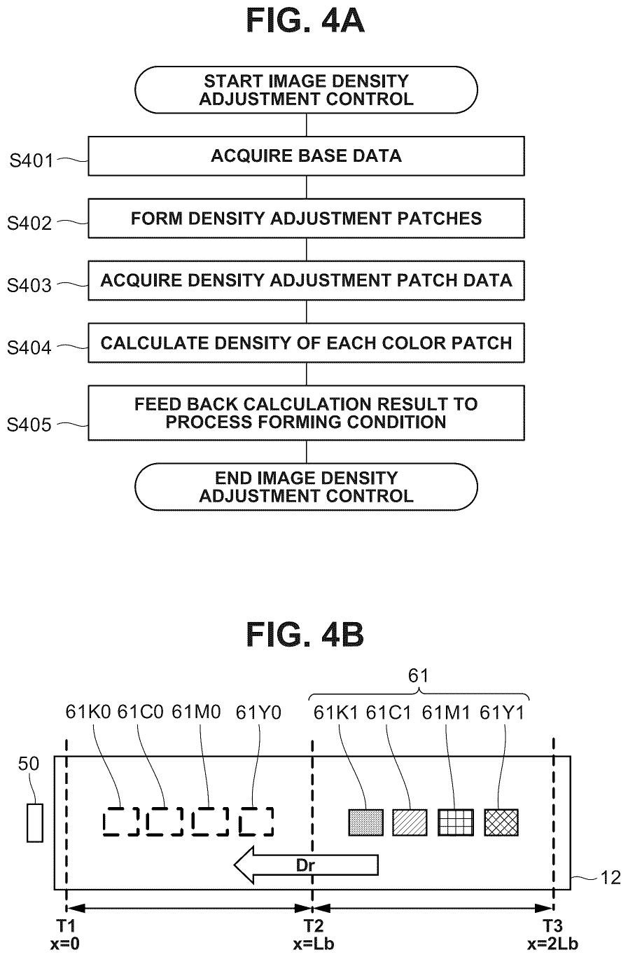

A processing procedure of image density adjustment control that is executed by the image density adjustment control unit 220 of the present exemplary embodiment is described with reference to a flowchart in FIG. 4A. In step S401, the image density adjustment control unit 220 acquires base data 61K0, 61C0, 61M0, and 61Y0 about a state where no image is formed on the intermediate transfer belt 12 in a range between the reference positions T1 and T2 in FIG. 4B by reading an output from the reflected light sensor 50 via the base data acquisition unit 221. In step S402, the image density adjustment control unit 220 uses the patch formation control unit 230 to form patches 61K1, 61C1, 61M1, and 61Y1 for image density adjustment in a range between the reference position T2 and a reference position T3 illustrated in FIG. 4B on the intermediate transfer belt 12. The range between the reference positions T1 and T2 is referred to as a first rotation of the intermediate transfer belt 12, and the range between the reference positions T2 and T3 (T3 is expressed as x=2Lb) is referred to as a second rotation of the intermediate transfer belt 12. In step S403, the image density adjustment control unit 220 acquires patch data by reading the output from the reflected light sensor 50 via the density adjustment patch data acquisition unit 222.

### (Density Adjustment Patches)

FIG. 4B illustrates a patch pattern 61 that is formed on the intermediate transfer belt 12 by the patch formation control unit 230 and is used for image density adjustment. The patch pattern 61 for image density adjustment includes a plurality of toner images for image density adjustment. Specifically, the patch pattern 61 for image density adjustment includes the patch 61Y1 in yellow, the patch 61M1 in magenta, the patch 61C1 in cyan, and the patch 61K1 in black. The patches 61Y1 to 61K1 are formed in the order of Y, M, C, and K, from the upstream to the downstream in the conveyance direction Dr of the intermediate transfer belt 12 within the range between the reference positions T2 and T3. Thus, the reflected light sensor 50 detects the patch pattern 61 for image density adjustment in the order of the patches 61K1, 61C1, 61M1, and 61Y1.

Further, the patch pattern 61 for image density adjustment is formed in a direction orthogonal to the conveyance direction Dr at a position detectable by the reflected light sensor 50. The reference position T3 indicates a position at the circumferential length Lb away from the reference position T2. Thus, the pieces of base data 61K0, 61C0, 61M0, and 61Y0 are detected in the first rotation of the intermediate transfer belt 12, and the patches 61K1, 61C1, 61M1, and 61Y1 are formed in the second rotation.

Referring back to FIG. 4A, in step S404, the image density adjustment control unit 220 calculates densities of respective color patches from the base data acquired by the base data acquisition unit 221 in step S401 and the patch data for image density adjustment acquired by the density adjustment patch data acquisition unit 222 in step S403. In the calculation of a density of the color patch Y, for example, the following equation 1 is used.

$$Patch Data Y = Specular Reflected Light Amount of Patch 61 Y 1 - Diffused Reflected Light Amount of Patch 61 Y 1 \times α \\ Base Data Y = Specular Reflected Light Amount of Base Data 61 Y 0 - Diffused Reflected Light Amount of Base Data 61 Y 0 \times α \\ Patch Density Y = Patch Data Y / Base Data Y \qquad ( Equation 1 )$$

In equation 1, a represents a minimum value of an output ratio of specular reflected light and diffused reflected light calculated from the patch of the highest density of each color. In step S405, the image density adjustment control unit 220 feeds back a result of the calculation of a patch density acquired by equation 1 to a process forming condition.

### (Patch Formation Control Unit)

The patch formation control unit 230 controls formation of the patch patterns 60 and 61 that are used by the color misregistration correction control unit 210 and the image density adjustment control unit 220, respectively. The patch formation control unit 230 transmits a laser control signal of a toner image for the patch pattern to be formed to the image forming unit 260. Alternatively, a signal transmitted from the controller unit 202 may be used as the laser control signal for outputting a patch pattern.

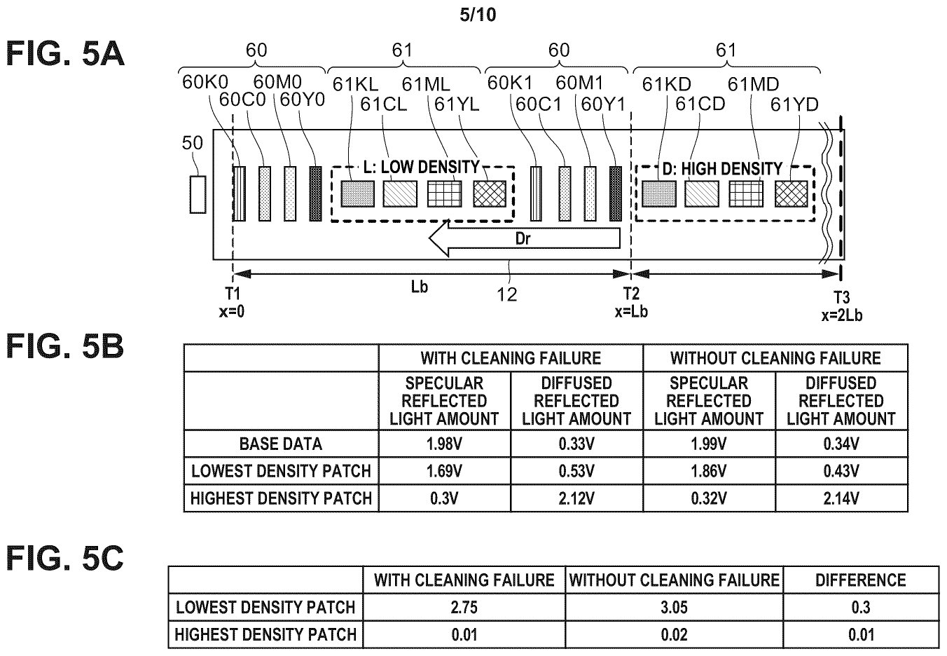

FIG. 5A illustrates examples of patch patterns that are formed on the intermediate transfer belt 12 and are adjustment toner images for image adjustment. The patch patterns include the patch pattern 60 for color misregistration correction and the patch pattern 61 for image density adjustment, patches of which have been output from respective stations, and the patches are spaced without overlapping. More specifically, the patch pattern 60 for color misregistration correction serving as a second toner image group includes patches 60K0, 60C0, 60M0, 60Y0, 60K1, 60C1, 60M1, and 60Y1. The patch pattern 61 for image density adjustment serving as a first toner image group includes patches 61KL, 61CL, 61ML, 61YL, 61KD, 61CD, 61MD, and 61YD. The number and the type of patch patterns are not limited to the above examples, and may vary in accordance with time to be taken for execution of the color misregistration/image density control and a desired accuracy.

In order to cancel the color misregistration amount between rotation periods of the rotation body, such as the intermediate transfer belt 12 or the photosensitive drum 5, the patch groups of the patch pattern 60 for color misregistration correction are arranged with a predetermined space therebetween. Thus, a space between the two patch groups for color misregistration correction, i.e., a space between the patch group including the patches 60K0, 60C0, 60M0, and 60Y0 and the patch group including the patches 60K1, 60C1, 60M1, and 60Y1, is used for formation of the patch pattern 61 for image density adjustment. In this way, a time to be taken for execution of the image adjustment function can be reduced.

Further, as illustrated in FIG. 5A, in order to improve the accuracy of image density adjustment, the patch pattern 61 for image density adjustment of a low density range and a high density range is arranged. More specifically, the patch formation control unit 230 forms the patches 61KL, 61CL, 61ML, and 61YL in low densities, i.e., first densities for adjustment of densities in the low density range. The patch formation control unit 230 also forms the patches 61KD, 61CD, 61MD, and 61YD in high densities, i.e., second densities, darker than the first densities for adjustment of densities in the high density range. As a result, as illustrated in FIG. 5A, the length of the patch patterns is longer than a length corresponding to one rotation of the intermediate transfer belt 12.

Specifically, the length of the patch patterns illustrated in FIG. 5A from the first toner image (patch 60K0) to the last toner image (patch 61YD) included in the patch patterns is longer than a circumferential length which is a length of the intermediate transfer belt 12 in the conveyance direction Dr. More specifically, the relationship is represented by Lp>Lb, where the length of the patch patterns is a pattern length Lp, and the circumferential length of the intermediate transfer belt 12 in the conveyance direction Dr, which coincides with the rotation direction, is the circumferential length Lb. Among the patches included in the patch patterns in FIG. 5A, the patches 60K0 to 61Y1 are formed in the range between the reference positions T1 and T2, i.e., in the first rotation of the intermediate transfer belt 12, and the patches 61KD to 61YD are formed in the range between the reference positions T2 and T3, i.e., in the second rotation of the intermediate transfer belt 12.

As described above, a patch pattern formed in a range more than one rotation of the intermediate transfer belt 12 may cause a risk that a detection accuracy is degraded by the cleaning failure. In normal printing, the cleaning unit 270 can remove a small amount of toner (hereinafter, called residual toner) not transferred to the sheet 2 every time the intermediate transfer belt 12 performs one rotation. However, in the image adjustment function, since toner more than the residual toner reaches the cleaning unit 270 at once, there is a risk that the cleaning unit 270 cannot remove the toner sufficiently.

For example, in a case where toner of the patches formed in the range between the reference positions T1 and T2 in FIG. 5A, i.e., in the first rotation of the intermediate transfer belt 12, cannot sufficiently be removed by the cleaning unit 270, the toner remains as a stain in the range between the reference positions T2 and T3, i.e., in the second rotation of the intermediate transfer belt 12. Consequently, in detection of the patches formed in the range between the reference positions T2 and T3 by the reflected light sensor 50, this residual toner may have an influence on accuracy of the detection.

In order to reduce or suppress the influence of the stain on detection accuracy in the second rotation, the patch formation control unit 230 of the present exemplary embodiment forms the patches for image density adjustment in a low density range (hereinafter, called low density patches) in the first rotation of the intermediate transfer belt 12 in the range between the reference positions T1 and T2, and forms the patches for image density adjustment in a high density range (hereinafter, called high density patches) in the second rotation of the intermediate transfer belt 12 in the range between the reference positions T2 and T3. In FIG. 5A, the patches 61KL, 61CL, 61ML, and 61YL are low density patches, and the patches 61KD, 61CD, 61MD, and 61YD are high density patches.

This is because the high density patches are less affected by the influence of the stain caused by the residual toner when compared to the low density patches. As described above, in the present exemplary embodiment, an average density of patches for image density adjustment in the patch patterns formed in a range between a point at the circumferential length Lb away from the first toner image and the pattern length Lp is higher than an average density of patches for image density adjustment in the patch patterns formed in a range between the first toner image and the circumferential length Lb. Since a plurality of patches is included in the patch patterns 61, densities of the plurality of patches are averaged. Further, for example, in order to prevent the patches for image density adjustment formed in the range between the reference positions T2 and T3 from being affected by the influence of residual toner, the high density patches may be formed in densities higher than the highest density of residual toner.

### (Influence of Cleaning Failure)

The high density patch is less affected by the influence of the cleaning failure when compared to the low density patch. This is described with reference to experimental data illustrated in FIGS. 5B and 5C. FIG. 5B is a table illustrating measurement results (voltage) acquired in a case with cleaning failure and a case without cleaning failure. FIG. 5C is a table illustrating calculation results of equation 1] acquired based on the measurement results in FIG. 5B.

As illustrated in FIG. 5C, in a case of the lowest density patch, a difference between the calculation results of the case with cleaning failure and the case without cleaning failure is 0.3. In a case of the highest density patch, a difference between the calculation results of the case with cleaning failure and the case without cleaning failure is 0.01, and the difference is smaller than that of the case of the lowest density patch. As described above, even though it is still found that an increase in densities caused by the influence of residual toner occurs in both the lowest density patch and the highest density patch, the influence on the high density patch is small when compared to the low density patch. Conversely, an influence on the low density patch is large. From the difference between the calculation results of the case with cleaning failure and the case without cleaning failure illustrated in FIG. 5C, it is found that the lowest density patch is greatly affected by the influence of residual toner when compared to the highest density patch. Thus, as described in the present exemplary embodiment, the low density patches are formed in the first rotation, and the high density patches are formed in the second rotation in a case where the patch patterns are formed in a range more than one rotation of the intermediate transfer belt 12. In this way, degradation of detection accuracy when the cleaning failure occurs can be prevented.

As described above, among the patches included in the patch patterns, the engine control unit 204 forms the patches in a range within the circumferential length Lb of the intermediate transfer belt 12 in the first density, and forms the patches in a range beyond the circumferential length Lb in the second density. The range within the circumferential length Lb coincides with the range between the reference positions T1 and T2 in FIG. 5A, and the patches formed in this range correspond to the patches 61KL, 61CL, 61ML, and 61YL. Further, the range beyond the circumferential length Lb is a range in the next rotation of the intermediate transfer belt 12 which coincides with the range between the reference positions T2 and T3 in FIG. 5A. The patches included in this range correspond to the patches 61KD, 61CD, 61MD, and 61YD.

As described above, according to the present exemplary embodiment, in a case where the patch pattern of more than one rotation of the belt is formed in the image adjustment function, the low density patches are formed in the first rotation, and the high density patches are formed in the second rotation.

In this way, the high density patches in the second rotation are less affected by the influence of the cleaning failure. Therefore, the time conventionally taken for the cleaning operation before formation of the patches in the second rotation is shortened.

According to the present exemplary embodiment, the execution time is reduced while a detection accuracy of the image adjustment operation is maintained.

A configuration of the image forming apparatus 201 according to a second exemplary embodiment is similar to the configuration illustrated in FIG. 1A. The cleaning unit 270 includes a cleaning detection unit for detecting whether toner has been removed, and processing of the image adjustment function is changed in accordance with a result of the cleaning detection. The cleaning unit 270 functions as a removing unit for removing a patch pattern formed on the intermediate transfer belt 12. Redundant descriptions of elements similar to those of the first exemplary embodiment are omitted.

### (Function Block Diagram)

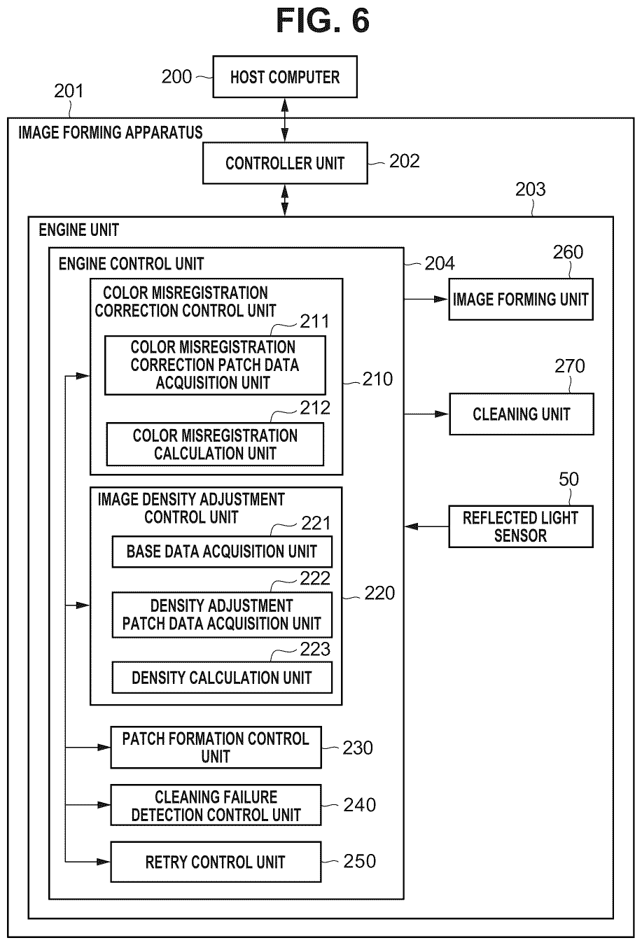

FIG. 6 is a function block diagram according to the present exemplary embodiment. A cleaning failure detection control unit 240 detects occurrence of cleaning failure by using the reflected light sensor 50. The cleaning failure detection control unit 240 functions as a second detection unit for detecting whether toner remains on the intermediate transfer belt 12 after removal of the patch pattern by the cleaning unit 270. Further, the engine control unit 204 changes control of the image adjustment function in accordance with a detection result acquired by the cleaning failure detection control unit 240.

In a case where execution of retry is determined based on a detection result acquired by the cleaning failure detection control unit 240, a retry control unit 250 retries the image adjustment function after cleaning on the intermediate transfer belt 12. In other words, the retry control unit 250 functions as an image adjustment retry unit that executes image adjustment again in response to the cleaning failure detection control unit 240 detecting an insufficient cleaning condition. Functions other than the above-described points are similar to those of the first exemplary embodiment, and the redundant descriptions are omitted.

### (Cleaning Failure Detection Control Unit)

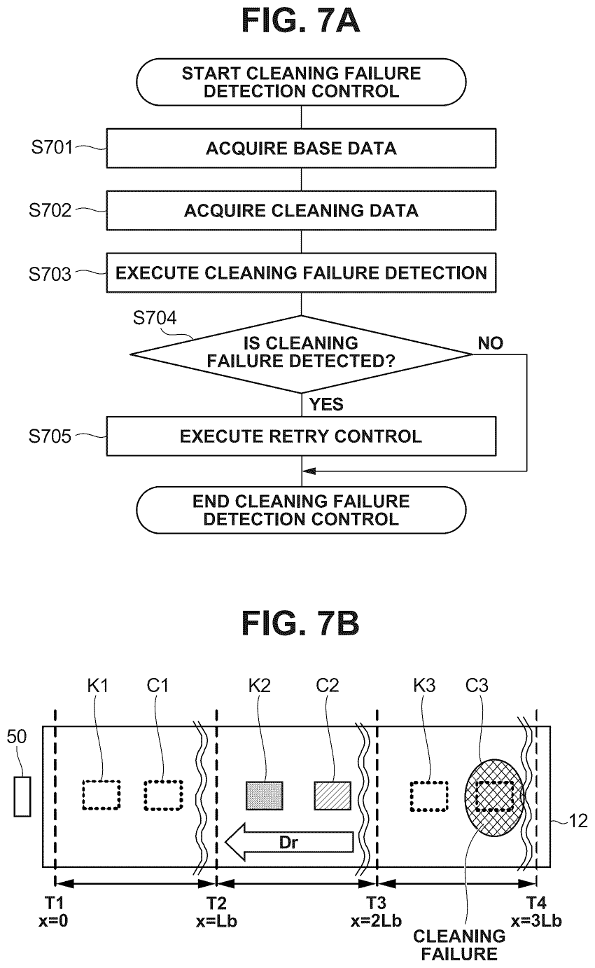

Next, cleaning failure detection control that is executed by the cleaning failure detection control unit 240 is described with reference to a flowchart in FIG. 7A. The cleaning failure detection control is executed during the image adjustment control, and patch patterns for the image adjustment control are formed on the intermediate transfer belt 12 by the patch formation control unit 230.

In step S701, the cleaning failure detection control unit 240 acquires the base data on the intermediate transfer belt 12 by using the reflected light sensor 50. The base data acquired in this process is, for example, base data K1 and C1 in FIG. 7B on positions which coincide with the positions of patches K2 and C2 formed on the intermediate transfer belt 12 in the range between the reference positions T2 and T3. In step S702, by using the reflected light sensor 50, the cleaning failure detection control unit 240 acquires cleaning data K3 and C3 as the base data after one rotation from the formation of the patches K2 and C2. The cleaning data K3 and C3 are data on a surface of the intermediate transfer belt 12 where no patches are formed after cleaning of the patches K2 and C2. Similar to the base data acquired in step S701, the cleaning data K3 and C3 are data on positions which coincide with the positions of the patches K2 and C2 formed on the intermediate transfer belt 12.

In step S703, the cleaning failure detection control unit 240 executes detection of the cleaning failure by using the base data acquired in step S701 and the cleaning data acquired in step S702. Specifically, the cleaning failure detection control unit 240 compares the base data K1 with the cleaning data K3 in FIG. 7B, and compares the base data C1 with the cleaning data C3 in FIG. 7B. When the data C is taken as an example, comparison is executed by using the following inequality 2.

$$C 1 \times β > C 3 \qquad Inequality 2$$

In a case where the inequality 2 is satisfied, the cleaning failure detection control unit 240 detects the cleaning failure. In the inequality 2, C1 represents base data, C3 represents cleaning data, and β represents a coefficient that is used for the cleaning failure detection. In the present exemplary embodiment, the coefficient β is 0.98. For example, in a case where the base data C1 is 2.1 V, if the cleaning data C3 is less than 2.058 V, the cleaning failure detection control unit 240 determines that cleaning failure has occurred. As a case of the cleaning data C3 illustrated in FIG. 7B, in a case where toner remains on the surface of the intermediate transfer belt 12 due to the cleaning failure, a difference from the base data C1 becomes significant, and the cleaning failure detection control unit 240 determines that the cleaning failure has occurred.

In step S704, based on the cleaning failure detection executed in step S703, the cleaning failure detection control unit 240 determines whether the cleaning failure has occurred. In a case where the cleaning failure detection control unit 240 determines that the cleaning failure does not occur (NO in step S704), the processing ends. In a case where the cleaning failure detection control unit 240 determines that the cleaning failure has occurred (YES in step S704), the processing proceeds to step S705. In step S705, the cleaning failure detection control unit 240 executes retry control via the retry control unit 250.

As described above, among the patches included in the patch patterns, the engine control unit 204 uses the cleaning unit 270 to remove the toner images formed in a range within the circumferential length Lb during execution of the image adjustment control. Then, the engine control unit 204 uses the cleaning failure detection control unit 240 to detect whether the patch patterns have been removed. In other words, during execution of the image adjustment, the cleaning failure detection control unit 240 performs the determination of a cleaning condition after the patch patterns have passed through the cleaning unit 270 by a length longer than the circumferential length Lb, i.e., after the patch patterns have passed the reference position T3 in FIG. 7B.

### (Retry Control Unit)

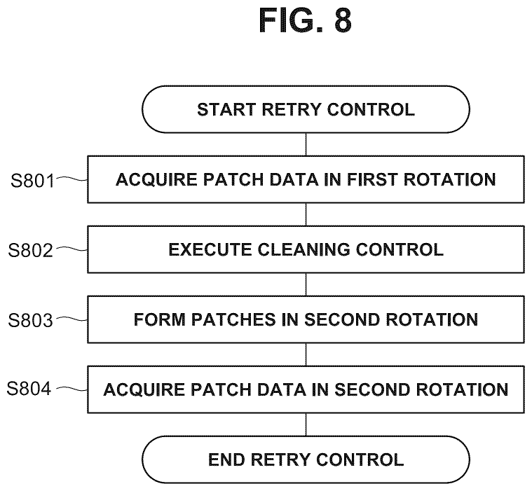

Retry control in step S705 in FIG. 7A that is executed when cleaning failure is detected by the cleaning failure detection control unit 240 is described with reference to a flowchart in FIG. 8. In step S801, from among pieces of the patch data acquired by the density adjustment patch data acquisition unit 222, the retry control unit 250 retains the patch data in the first rotation which is in the range between the reference positions T1 and T2 in FIG. 5A and is not affected by the influence of cleaning failure. The retry control unit 250 does not use the data in the second rotation and subsequent rotations which is in the range between the reference positions T2 and T3 in FIG. 5A, because the data is affected by the influence of the cleaning failure.

In step S802, the retry control unit 250 executes cleaning control on the intermediate transfer belt 12.

More specifically, cleaning is executed again at this timing. In step S803, the retry control unit 250 uses the patch formation control unit 230 to form only the patch pattern in the second rotation that is in the range between the reference positions T2 and T3 in FIG. 5A, on the intermediate transfer belt 12. In step S804, the retry control unit 250 uses the density adjustment patch data acquisition unit 222 to acquire the patch data in the second rotation on the patch pattern formed in step S803.

Image adjustment is executed using a combination of the data in the first rotation acquired in step S801 and the data in the second rotation acquired in step S804. Accordingly, an accuracy of the image adjustment can be maintained even in a case where the retry control is executed.

In a case where cleaning failure is detected by the cleaning failure detection control unit 240, retry control does not necessarily have to be executed, and image adjustment control may be executed using only the patch data on the first rotation.

As described above, in a case where the cleaning failure detection control unit 240 detects the toner remaining on the intermediate transfer belt 12, the engine control unit 204 uses the cleaning unit 270 to remove the toner remaining on the intermediate transfer belt 12. Then, the engine control unit 204 forms the toner images of the patch pattern in the range beyond the circumferential length Lb. The engine control unit 204 executes the image adjustment control based on the following two results. One of the two results is a detection result acquired by the reflected light sensor 50 through detection of the patches formed in a range within the circumferential length Lb before removal of the toner by the cleaning unit 270. Another one of the two results is a detection result acquired by the reflected light sensor 50 through detection of the patches in a range beyond the circumferential length Lb that has been formed after removal of the toner remaining on the intermediate transfer belt 12 by the cleaning unit 270. In other words, in formation of the patch patterns, the retry control unit 250 does not form at least the patches in the range=the pattern length Lp from the first toner image of the patch patterns−the circumferential length Lb, among the patches in the range of the circumferential length Lb from the first toner image of the patch patterns. Further, the retry control unit 250 executes image adjustment control by using both a detection result of a range of the circumferential length Lb from the first toner image of the patch patterns, which has been acquired in the last image adjustment control, and a detection result acquired in the retry. The engine control unit 204 may execute image adjustment control based on only a detection result acquired by the reflected light sensor 50 through detection of the patches formed in the range within the circumferential length Lb before removal of toner by the cleaning unit 270. In other words, in a case where the insufficient cleaning condition is detected, the engine control unit 204 may execute image adjustment control by using only a detection result of the patches in the range of the circumferential length Lb from the first toner image of the patch patterns, from among patch patterns detected by the reflected light sensor 50.

As described above, according to the present exemplary embodiment, in a case where cleaning failure has been detected when patch patterns have formed in a range more than one rotation of the intermediate transfer belt 12 in the image adjustment function, a correct patch data can be acquired by the retry control after the occurrence of the cleaning failure. In this way, a detection accuracy of the image adjustment function is maintained. Further, in a case where cleaning has been sufficiently executed on the intermediate transfer belt 12, the image adjustment control ends after once, so that the execution time can be shortened.

According to the present exemplary embodiment, the execution time can be reduced while a detection accuracy of the image adjustment operation is maintained.

A configuration of the image forming apparatus 201 according to a third exemplary embodiment is similar to the configuration illustrated in FIG. 1A. The image forming apparatus 201 predicts cleaning failure by using an ambient sensor 70 for measuring ambient environment (not illustrated in FIG. 1A), and changes the processing of the image adjustment function in accordance with a result of the prediction. The redundant descriptions of elements similar to those of the first and the second exemplary embodiments are omitted.

### (Function Block Diagram)

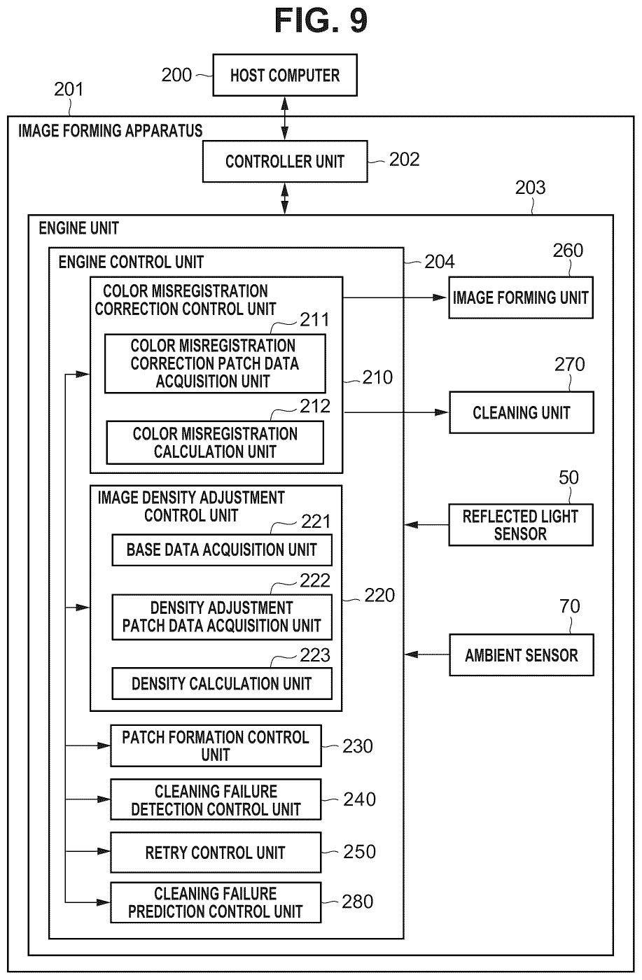

FIG. 9 is a function block diagram according to the present exemplary embodiment. A cleaning failure prediction control unit 280 predicts cleaning failure by using lifetime data on the intermediate transfer belt 12 and/or the cleaning unit 270 and a detection result acquired by the ambient sensor 70. The ambient sensor 70 functions as a temperature detection unit for detecting the ambient temperature. The cleaning failure prediction control unit 280 functions as a prediction unit for predicting whether cleaning failure is to occur after removal of the patch patterns on the intermediate transfer belt 12 by the cleaning unit 270. The engine control unit 204 changes the control of the image adjustment function in accordance with a result of the prediction. Functions other than the above-described points are similar to those of the first and the second exemplary embodiments, and the redundant descriptions are omitted.

### (Cleaning Failure Prediction Control)

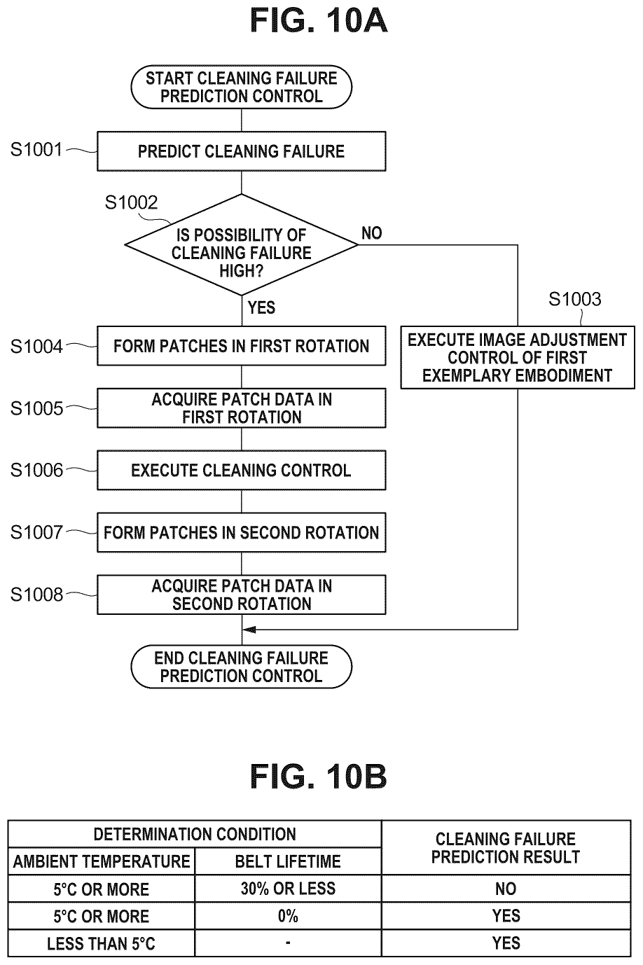

Cleaning failure prediction control that is executed by the cleaning failure prediction control unit 280 is described with reference to a flowchart illustrated in FIG. 10A. In step S1001, the cleaning failure prediction control unit 280 predicts cleaning failure by using remaining lifetime data of the intermediate transfer belt 12 that is calculated from the operating times of the intermediate transfer belt 12 and the cleaning unit 270, and the ambient temperature acquired by the ambient sensor 70. The operating times of the intermediate transfer belt 12 and the cleaning unit 270 are accumulated in a storage unit included in the engine control unit 204. Information, e.g., a table describing a relationship between the operating time and the remaining lifetime of the intermediate transfer belt 12 and a relational expression describing a relationship between the operating time and the remaining lifetime of the intermediate transfer belt 12, are previously stored in the storage unit. The engine control unit 204 functions as a lifetime acquisition unit for acquiring a remaining lifetime of the intermediate transfer belt 12 based on the operating time and the table or the relational expression. In accordance with a detection result acquired by the ambient sensor 70 and/or the remaining lifetime of the intermediate transfer belt 12 (acquisition result), the cleaning failure prediction control unit 280 predicts whether a patch pattern formed on the intermediate transfer belt 12 is to be removed by the cleaning unit 270.

FIG. 10B is a table illustrating determination conditions and results of the cleaning failure prediction according to the present exemplary embodiment. The determination conditions are an ambient temperature acquired by the ambient sensor 70 and a remaining lifetime (belt lifetime) of the intermediate transfer belt 12. The cleaning failure is predicted in accordance with the thresholds, and the operation of the image adjustment control is changed accordingly. For example, in a case where the ambient temperature detected by the ambient sensor 70 is 5° C. or more, and the belt lifetime is 30% or less, the cleaning failure prediction control unit 280 predicts that the cleaning failure does not occur (the determination is NO). As another example, even in a case where the ambient temperature detected by the ambient sensor 70 is 5° C. or more, the cleaning failure prediction control unit 280 predicts that the cleaning failure is to occur (the determination is YES) when the belt lifetime is 0%. As yet another example, in a case where the ambient temperature detected by the ambient sensor 70 is less than 5° C., the cleaning failure prediction control unit 280 predicts that the cleaning failure is to occur (the determination is YES) regardless of the belt lifetime. The cleaning failure prediction control unit 280 may execute the prediction by using a detection result that has been acquired in the last image adjustment control by the cleaning failure detection control unit 240 described in the second exemplary embodiment. While, in FIG. 10B, the cleaning failure prediction control unit 280 executes the prediction based on the ambient temperature and the belt lifetime, a lifetime of the cleaning unit 270 may also be factored in as the determination conditions of the prediction. Further, the cleaning failure prediction control unit 280 may execute the prediction by using at least any one of the ambient temperature, the belt lifetime, and the lifetime of the cleaning unit 270.

In step S1002, based on the cleaning failure prediction executed in step S1001, the cleaning failure prediction control unit 280 predicts whether a possibility of cleaning failure is high. In step S1002, in a case where the cleaning failure prediction control unit 280 predicts that a possibility of cleaning failure is low (NO in step S1002), the processing proceeds to step S1003.

In step S1003, the cleaning failure prediction control unit 280 executes the image adjustment control described in the first exemplary embodiment in which data is acquired by continuously forming the patches in the second rotation and subsequent rotations, and ends the cleaning failure prediction control.

In step S1002, in a case where the cleaning failure prediction control unit 280 predicts that a possibility of cleaning failure is high (YES in step S1002), the processing proceeds to step S1004. In step S1004, the cleaning failure prediction control unit 280 uses the patch formation control unit 230 to form the patches in the first rotation, e.g., patches in the range between the reference positions T1 and T2 in FIG. 5A. In step S1005, the cleaning failure prediction control unit 280 uses the color misregistration correction patch data acquisition unit 211 and the density adjustment patch data acquisition unit 222 to acquire patch data on the patches in the first rotation formed in step S1004.

In step S1006, the cleaning failure prediction control unit 280 uses the cleaning unit 270 to execute the cleaning control on the intermediate transfer belt 12. Executing the cleaning control at a timing of step S1006 without forming (i.e., before forming) the patches in the second rotation which will become useless due to a degraded detection accuracy caused by cleaning failure leads to the achievement of further shortening the execution time.

In step S1007, the cleaning failure prediction control unit 280 uses the patch formation control unit 230 to form the patches in the second rotation, e.g., patches in the range between the reference positions T2 and T3 in FIG. 5A. In step S1008, the cleaning failure prediction control unit 280 uses the color misregistration correction patch data acquisition unit 211 and the density adjustment patch data acquisition unit 222 to acquire patch data on the patches in the second rotation formed in step S1007. The engine control unit 204 executes image adjustment control by combining the data in the first rotation acquired in step S1005 and the data in the second rotation acquired in step S1008. Therefore, an accuracy of the image adjustment can be maintained even during the cleaning failure prediction control.

As described above, in a case where occurrence of the cleaning failure is predicted by the cleaning failure prediction control unit 280, the engine control unit 204 executes the following control. The engine control unit 204 uses the cleaning unit 270 to execute a first control in which residual toner is removed (step S1006 in FIG. 10A). The engine control unit 204 executes the following control in a case where non-occurrence of the cleaning failure is predicted by the cleaning failure prediction control unit 280. The engine control unit 204 executes a second control in which the patches in a range beyond the circumferential length Lb is formed without executing cleaning of residual toner because the cleaning failure does not occur (step S1003 in FIG. 10A).

In other words, in a case where the cleaning failure prediction control unit 280 predicts an insufficient cleaning condition, the engine control unit 204 executes a first image adjustment, and in the contrary case, the engine control unit 204 executes a second image adjustment. The first image adjustment uses a first adjustment pattern having the pattern length Lp in a relationship Lp≤Lb with the circumferential length Lb. The second image adjustment uses a second adjustment pattern having the pattern length Lp in a relationship Lp>Lb with the circumferential length Lb. In the present exemplary embodiment, the retry control unit 250 also functions as an image adjustment retry unit that executes image adjustment again after execution of the first image adjustment. When a pattern length of patch pattern for retry is expressed as Lp2, the pattern length Lp2 and the circumferential length Lb satisfy a relationship Lp2≤Lb. The patch pattern for retry is patterns including all patches not included in the first adjustment pattern from among the patches included in the second adjustment pattern. The retry control unit 250 executes image adjustment control by using both of a detection result acquired in the last first image adjustment and a detection result acquired in the retry. The retry control unit 250 forms the patch pattern for retry after a cleaning operation for removing a patch pattern remaining on the intermediate transfer belt 12.

As described above, in the present exemplary embodiment, the cleaning failure prediction control unit 280 predicts a cleaning condition by using at least any one of information about a lifetime of the intermediate transfer belt 12, information about a lifetime of the cleaning unit 270, and information about a detection result acquired by the ambient sensor 70 for measuring the ambient where the image forming apparatus 201 is installed. Further, the cleaning failure prediction control unit 280 may predict a cleaning condition by using the most recent detection result acquired by the cleaning failure detection control unit 240.

As described above, according to the present exemplary embodiment, the determination of whether the cleaning failure is to occur is performed before execution of the image adjustment function, which leads to reduction in the execution time to be taken for formation of the patches in the second rotation which will become useless. Further, since the patch data in the second rotation is acquired after cleaning control, a detection accuracy of the image adjustment function can be maintained. In a case where occurrence of the cleaning failure is predicted by the cleaning failure prediction control unit 280, patches in the second rotation do not necessarily have to be formed, and image adjustment control may be executed by using only the patch data in the first rotation.

While the operating times of the intermediate transfer belt 12 and the cleaning unit 270 are used in the determination of the lifetime of the intermediate transfer belt 12, information such as a rotating time of the intermediate transfer belt 12, a driving time of a motor for driving the intermediate transfer belt 12, and the number of cumulative printed sheets of sheets 2 on which image formation has been executed, can also be used. In other words, information having a correlation with the lifetime of the intermediate transfer belt 12 can be used. While the ambient sensor 70 detects the ambient temperature, the ambient sensor 70 may detect another information, such as a humidity and an amount of moisture, which can be a cause of the cleaning failure.

According to the present exemplary embodiment, the execution time of the image adjustment operation is reduced while a detection accuracy of the image adjustment operation is maintained.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-118137, filed Jul. 20, 2023, which is hereby incorporated by reference herein in its entirety.

What is claimed is:

1. An image forming apparatus comprising:
a forming unit configured to form an adjustment toner image which includes a plurality of toner images for adjustment of image density;
an intermediate transfer body on a surface of which the adjustment toner image is formed by the forming unit;
a detection unit configured to detect the surface of the intermediate transfer body or the adjustment toner image; and
a control unit configured to execute image adjustment control including adjustment of the image density, based on a detection result acquired by the detection unit detecting the adjustment toner image,
wherein a length of the adjustment toner image from a first toner image to a last toner image included in the adjustment toner image is longer than a circumferential length that is a length of the intermediate transfer body in a conveyance direction, and
wherein, among the plurality of toner images included in the adjustment toner image, the control unit forms toner images included in a range within the circumferential length in a first density, forms toner images included in a range beyond the circumferential length in a second density darker than the first density, and executes the image adjustment control.

2. The image forming apparatus according to claim 1,
wherein, in a case where the plurality of toner images for adjustment of the image density is specified as a first toner image group, the adjustment toner image includes a second toner image group including a plurality of toner images for adjustment of color misregistration of a plurality of colors.

3. An image forming apparatus comprising:
a forming unit configured to form adjustment toner image which includes a plurality of toner images for image adjustment;
an intermediate transfer body on a surface of which the adjustment toner image is formed by the forming unit;
a first detection unit configured to detect the surface of the intermediate transfer body or the adjustment toner image;
a removing unit configured to remove the adjustment toner image formed on the intermediate transfer body; and
a control unit configured to execute image adjustment control based on a detection result acquired by the first detection unit detecting the adjustment toner image,
wherein the image forming apparatus further includes a second detection unit configured to detect whether toner remains on the intermediate transfer body after removal of the adjustment toner image by the removing unit,
wherein a length of the adjustment toner image from a first toner image to a last toner image included in the adjustment toner image is longer than a circumferential length that is a length of the intermediate transfer body in a conveyance direction, and
wherein, after removal of toner images included in a range within the circumferential length from among the toner images included in the adjustment toner image by the removing unit, the control unit causes the second detection unit to detect whether toner remains.

4. The image forming apparatus according to claim 3, wherein, in a case where the second detection unit detects toner remaining on the intermediate transfer body, the control unit causes the forming unit to form toner images included in a range beyond the circumferential length, from among the plurality of toner images included in the adjustment toner image, after removal of the toner remaining on the intermediate transfer body by the removing unit.

5. The image forming apparatus according to claim 4, wherein the control unit executes the image adjustment control based on a detection result acquired by the first detection unit detecting the toner images included in the range within the circumferential length before removal of toner by the removing unit, and a detection result acquired by the first detection unit detecting the toner images included in the range beyond the circumferential length which has been formed by the forming unit after removal of toner remaining on the intermediate transfer body by the removing unit.

6. The image forming apparatus according to claim 3, wherein, in a case where the second detection unit detects toner remaining on the intermediate transfer body, the control unit executes the image adjustment control based on a detection result acquired by the first detection unit detecting the toner images included in the range within the circumferential length before removal of the toner by the removing unit.

7. An image forming apparatus comprising:
a forming unit configured to form an adjustment toner image which includes a plurality of toner images for image adjustment;
an intermediate transfer body on a surface of which the adjustment toner image is formed by the forming unit;
a detection unit configured to detect the surface of the intermediate transfer body or the adjustment toner image;
a removing unit configured to remove the adjustment toner image formed on the intermediate transfer body; and
a control unit configured to execute image adjustment control based on a detection result acquired by the detection unit detecting the adjustment toner image,
wherein the image forming apparatus further includes a prediction unit configured to predict whether cleaning failure is to occur after removal of the adjustment toner image formed on the intermediate transfer body by the removing unit,
wherein a length of the adjustment toner image from a first toner image to a last toner image included in the adjustment toner image is longer than a circumferential length that is a length of the intermediate transfer body in a conveyance direction,
wherein, in a case where the prediction unit predicts occurrence of the cleaning failure, the control unit executes first control to cause the forming unit to form toner images included in a range beyond the circumferential length, from among the plurality of toner images included in the adjustment toner image, after removal of toner remaining on the intermediate transfer body by the removing unit, and
wherein, in a case where the prediction unit predicts non-occurrence of the cleaning failure, the control unit executes second control to form the toner images included in the range beyond the circumferential length, from among the plurality of toner images included in the adjustment toner image.

8. The image forming apparatus according to claim 7,
wherein the adjustment toner image includes a plurality of toner images for adjustment of image density, and
wherein, in the second control, from among the toner images included in the adjustment toner image, the control unit forms toner images included in a range within the circumferential length in a first density, forms toner images included in a range beyond the circumferential length in a second density darker than the first density, and executes the image adjustment.

9. The image forming apparatus according to claim 8, wherein, in a case where the plurality of toner images for adjustment of the image density is specified as a first toner image group, the adjustment toner image includes a second toner image group which includes a plurality of toner images for adjustment of color misregistration of a plurality of colors.

10. The image forming apparatus according to claim 7, wherein, in the first control, the control unit executes the image adjustment control based on a detection result acquired by the detection unit detecting the toner images included in the range within the circumferential length before removal of toner by the removing unit, and a detection result acquired by the detection unit detecting the toner images included in the range beyond the circumferential length which have been formed by the forming unit after removal of toner remaining on the intermediate transfer body by the removing unit.

11. The image forming apparatus according to claim 7, wherein, in the first control, the control unit executes the image adjustment control based on a detection result acquired by the detection unit detecting the toner images included in the range within the circumferential length before removal of toner by the removing unit.

12. The image forming apparatus according to claim 7, further comprising:
a temperature detection unit configured to detect an ambient temperature; and
a lifetime acquisition unit configured to acquire a lifetime of the intermediate transfer body and/or the removing unit,
wherein the prediction unit predicts whether the cleaning failure occurs, based on at least any one of a detection result acquired by the temperature detection unit and an acquisition result acquired by the lifetime acquisition unit.
